(19) United States
(12) Patent Application Publication
(10) Pub. No.: US 2015/0254917 A1
(43) Pub. Date: Sep. 10, 2015

(54) FACILITY ACCESS SYSTEM

(71) Applicants: Brian Rockermann, Fremont, CA (US); Anne Sutardji, Fremont, CA (US)

(72) Inventors: Brian Rockermann, Fremont, CA (US); Anne Sutardji, Fremont, CA (US)

(21) Appl. No.: 14/636,505

(22) Filed: Mar. 3, 2015

Related U.S. Application Data
(60) Provisional application No. 61/947,967, filed on Mar. 4, 2014.

(51) Int. Cl. G07C 9/00

(52) U.S. Cl. CPC G07C 9/00571; G07C 9/00166; G07C 9/00309; G07C 9/00142

(57) ABSTRACT

A device including a processor coupled to a transceiver, and a remotely located user input device, said input device coupled to the transceiver. The input device provides information to the processor from which the processor controls a barrier, said barrier coupled to the processor, and a barrier controller, wherein the barrier controller operates the barrier in response to control information generated by the input device. Certain embodiments include web and mobile application support for programming barrier control by different users at scheduled times or by allowing a user to control the barrier remotely.

### PRIORITY

This application claims the benefit of co-pending provisional application No. 61/947,967 entitled “Facility Access System” filed Mar. 4, 2014 by the same inventors which is incorporated by reference as if fully set forth herein.

### BACKGROUND

The present invention relates generally to facility access systems, and more particularly to systems and method of providing secure physical access to an area. Conventionally, secure access to facilities is provided by external equipment which may contain a numeric keypad coupled wirelessly to indoor equipment which controls an access barrier. Often the external equipment must be low cost and easy to install. These requirements yield outdoor keypad-based devices which are battery-powered, contain a “code vault” for storing access codes and against which inputted codes are compared, and also contain a mechanism to wirelessly signal the barrier to grant access to the physical space. The indoor equipment may have internet access in some cases, which would allow facility access to be granted remotely by a system administrator. To be secure the system must be immune to “replay attacks” in which an eavesdropping device re-transmits the previous signal to grant access.

Conventionally the keypad is coupled to a local code vault for storing access codes. The integration of keypad and code vault in the outdoor equipment results in a code vault that may be difficult to manage. This is due to at least 2 factors: a) the required low cost and small size of the outdoor equipment does not permit the inclusion of user-friendly I/O for complex local code vault editing, and b) the required low cost battery does not permit a continuous wireless link to receive remote vault updates. As such, these code vaults typically only support a very small number of access codes, do not contain complex attributes and don't log entrants. Moreover, physical interaction with the keypad is required to modify their contents.

Accordingly, there is a need for better systems to manage facility access.

### SUMMARY

Disclosed herein is a device including a processor coupled to a transceiver, and a remotely located user input device, said input device also coupled to the transceiver. The input device provides information to the processor from which the processor controls a barrier, said barrier coupled to the processor, and a barrier controller, wherein the barrier controller operates the barrier in response to control information generated by the input device. Certain embodiments include web and mobile application support for programming barrier control by different users at scheduled times or by allowing a user to control the barrier remotely.

The user input device is coupled to the processor wirelessly providing for operations to be divided into a secure area and an exposed area. By securing critical operations, the device provides for more security and easier installation.

In addition to the wireless connection, the processor may be coupled to the Internet (or other network) for remote control operations. This provides for network and mobile remote access to the barrier, programmable control of user operations, and alerts when a person enters or leaves through the barrier entry or when there is evidence of tampering with the input device.

### BRIEF DESCRIPTION OF THE DRAWINGS

FIG. 1 illustrates a modular building block according to certain aspects of the current disclosure.

FIG. 2 is a flowchart which may control operation of a keypad processor of the exposed equipment.

FIG. 3 is a flowchart which may control operation of a vault processor of the secure equipment in some embodiments.

FIG. 4 shows an exemplary software embodiment according to the present disclosure.

FIG. 5 shows a mobile application embodying differing alerts.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### DETAILED DESCRIPTION

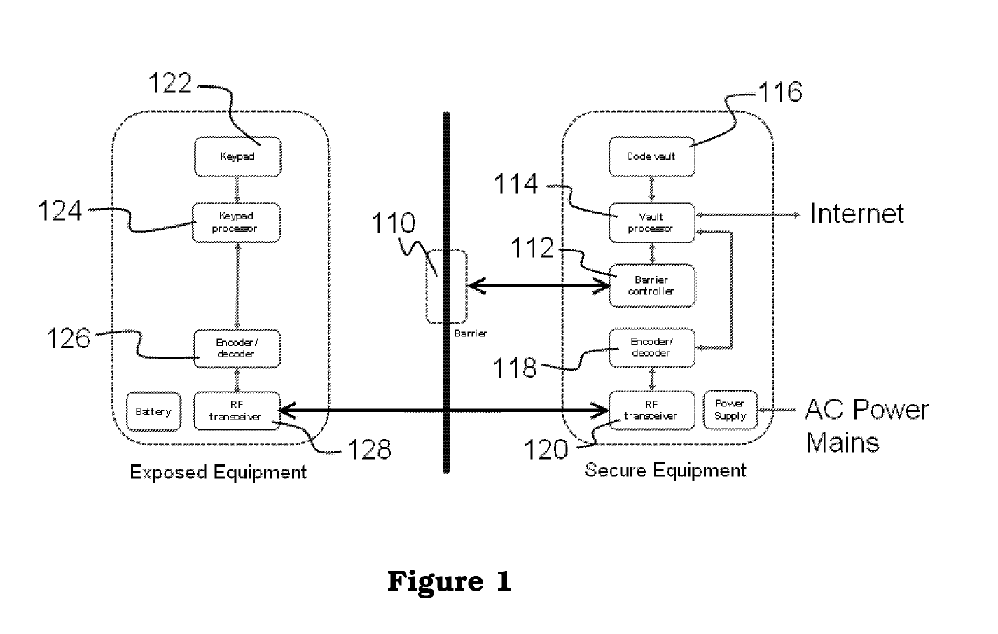

FIG. 1 illustrates a modular building block according to certain aspects of the current disclosure. In FIG. 1 a barrier 110 is coupled to a barrier controller 112. The barrier may be any gate, door, or other device for limiting passage from one area to another area. For example and without limitation, a barrier may be a garage door or a turnstile for pedestrians or vehicles. The operation of the barrier controller 112 will depend upon the type of barrier. The barrier controller 112 is physically located in an area for secure equipment. Coupled to the barrier controller is a vault processor 114, which in turn is coupled to a code vault 116. The vault processor 114 is coupled to a network such as the Internet and to an encoder/decoder 118 which receives a signal from an RF transceiver 120.

FIG. 1 also illustrates equipment that is exposed to regular users. This includes a keypad 122 (or other input device) coupled to a keypad processor 124 which in turn is coupled to an encoder/decoder 126. The encoder/decoder 126 may be coupled to a signaling device such as an RF transceiver 128 which may be powered using a battery or other source.

In FIG. 1 the code vault 116 is in a secure area and powered by the indoor power mains (i.e. AC) and coupled to the internet, which may include a battery backup in some embodiments. Since there are no natural physical size limitations, the code vault 116 may be expanded to contain a very large set of codes which can be modified from any internet-connected device. In such a system, the exposed equipment may contain an agent which detects numeric key presses, and securely and wirelessly transmits these key presses to the secure equipment. The secure equipment contains the code vault 116 as well as the vault processor 114, which compares the received key sequence to the code vault 116 contents. If a match occurs, the secure equipment unit signals the barrier controller 112 to grant access.

In certain embodiments the secure area may be operationally divided into a security gateway and a security proxy. The security gateway may include one or more of the following features:
A code vault with all facility access credentials and associated parameters;
Active listening for key commands over a secure and reliable connection;
Active listening for security proxy commands over secure but unreliable connection (network);
Event notifications to security proxy (e.g. barrier just opened, barrier open too long, etc)
Control of a barrier controller to grant facility access.

The security proxy may include one or more of the following features:
A known Internet presence to which security gateways and mobile users may connect;
A secure gateway proxy for mobile users in the event that the gateway connection is interrupted (e.g. for access credential update);
A notification database of all users that require push notification or SMS/text upon alert from security gateway;

In some embodiments the exposed area may include one or more of the following features:
A reliable method to gain access to the facility for properly credentialed users;
Acceptance of credentials from user (e.g. keypad digits, voice, fingerprint, photo, and the like).
Forwarding of credentials from an unknown user to the security gateway over a secure and reliable connection.
Retransmission of credentials as needed to provide reliable delivery to security gateway
Energy constrained (may be battery powered or harvest ambient energy such as solar).

### Conditional Access

In some embodiments the vault processor 114 has access to the internet. This allows the vault processor 114 to indicate to any internet-connected device which code (i.e. user) has been granted facility access along with the time of day that access was granted. Managing the code vault 116 with internet-connected human-interface devices (e.g. computers, tablets, smart-phones, etc.) enables the addition of complex attributes (e.g. time of day conditional access, maximum number of accesses within a time period, etc.) to be associated with each access code in the code vault 116. Access to the internet also permits the vault processor 114 to send keypad tampering alerts (i.e. sequence of incorrect code entries) to any internet-connected device.

One having skill in the art will recognize that separating the code vault 116 from the keypad 122 may require a secure wireless link between them to prevent any attacks such as replay attacks. Accordingly conventional public-domain cryptography techniques may be employed. The radio link between secure and exposed equipment may be based on the IEEE 802.15.4 and IETF TLS 1.2 protocols, or other protocols that may be in the public-domain and deemed secure. The exposed equipment's keypad processor 124 may re-transmit the last message to the secure equipment's vault processor 114 if there are any errors such as a CRC error, thus enhancing reliability and security.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

In some embodiment exposed equipment may revert to a very low energy state (i.e. “sleep”) after each key press (or sequence of key presses) is successfully forwarded to the indoor equipment to reduce energy consumption.

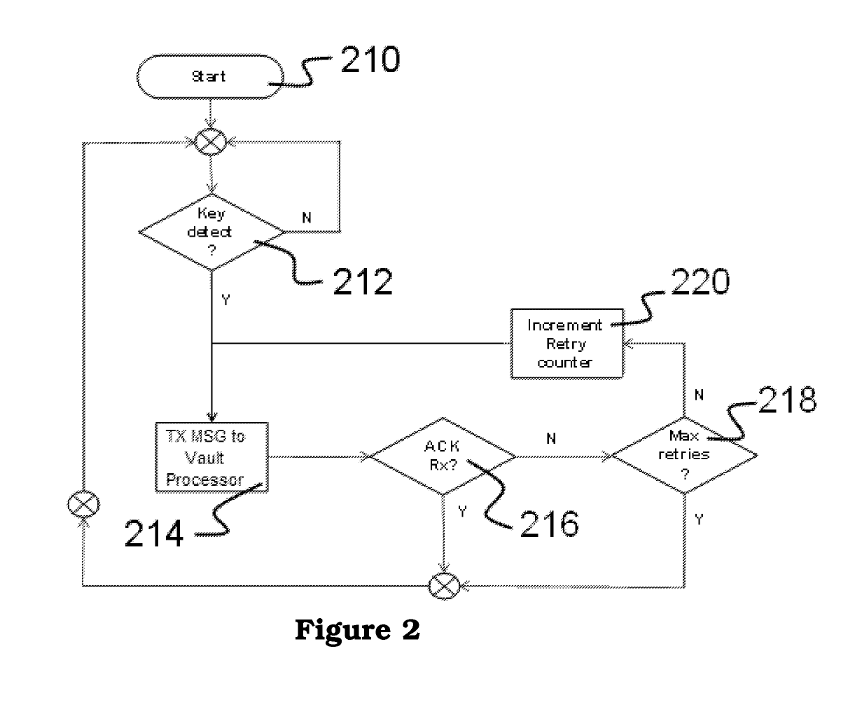

FIG. 2 is a flowchart which may control operation of a keypad processor of the exposed equipment. The method begins at a flow label 210 and proceeds to a step 212 where a key press is detected. Once one or more keys are detected the method advances to a flow label 214 where the key (or key sequence) is transmitted to the vault processor (secure equipment). At a decision step 216 the method tests for reception of a proper acknowledgment. If one is received, then access is indicated and the method ends. If an acknowledgement is not received, the method proceeds to a step 218 where the amount of re-transmission attempts is compared to a predetermined value. If the maximum number of retries is reached, the method ends. If not the method proceeds to a step 220 where the retry count is incremented and the flow moves to step 214 where the message is re-transmitted. Flow only returns to the beginning if the test in step 218 is true.

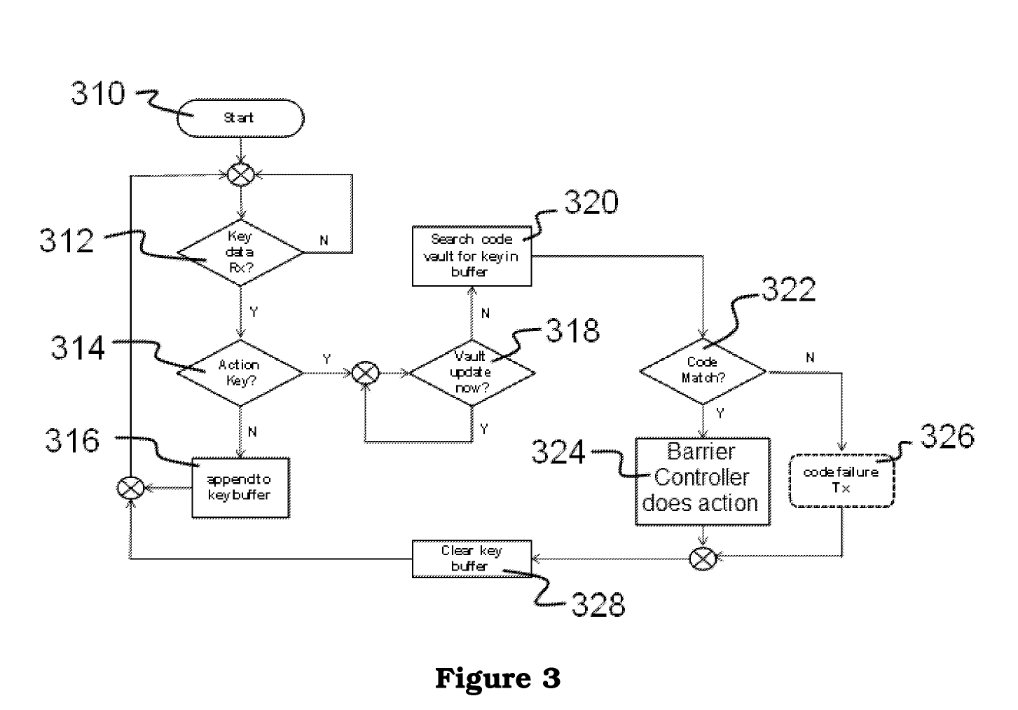

In addition to the method described in FIG. 3, the vault processor may provide operational features such as detecting keypad tampering from frequent mis-keying of access codes, providing for limited timed access, and providing multiple users with unique access codes to manage entries. In some embodiments alerts may include signaling when the barrier is open too long, or when the barrier is about to change state.

In addition to the method described in FIG. 2, the keypad processor may provide operational features such as detecting low battery indications, detecting nearby motion, recording audio, recording pictures or video, and transmitting the associated data to the vault processor. In some embodiments these transmissions may be compared against data in the code vault to make decisions about granting access.

FIG. 3 is a flowchart which may control operation of a vault processor of the secure equipment in some embodiments. The method begins at a flow label 310 and proceeds to a step 312 where key data from a key processor is received.

At a step 314 the key data is tested to see if it is an action key. An action key causes an event to occur. For example and without limitation an action key for a garage door opener changes the door state from “opened” to “closed”, or “closed” to “opened”. In some embodiments there may be other action keys (or key sequences) on a keypad, for example “lock”, “unlock”, and the like.

If the key is not an action key, the method proceeds to a step 316 where the key is added to a key buffer. The key buffer will accumulate key information as key data.

If the key is an action key the method proceeds to a step 318 where it is tested to see if the key vault is in the process of being updated. If not flow proceeds to a step 320. In some embodiments the step 318 operates to prevent a code search and vault update from occurring simultaneously. These may be implemented as atomic operations wherein each of these steps are allowed to complete before the other can proceed, to insure that the key buffer contents are properly compared against a consistent vault.

At a step 320 the key vault is searched for the key data and tested at a step 322 for a match. If there is no match flow proceeds to a step 326 where a code failure indication is transmitted (to the keypad processor in the exposed equipment) so that the user can be alerted to the mis-match by flashing an indicator such as an LED, or another suitable indicia. If there is a code match, flow proceeds to a step 324 where a grant access (or other appropriate signal) is transmitted.

At a step 328 the key buffer is reset and flow returns to the initial state.

### Processor Control

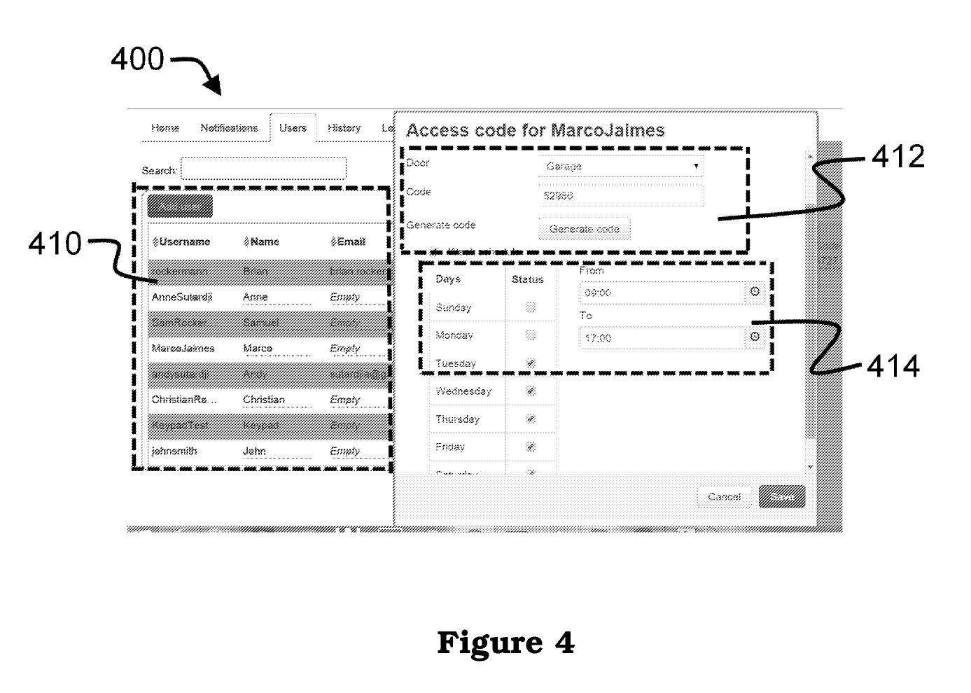

FIG. 4 shows an exemplary software embodiment according to the present disclosure. In FIG. 4 a computer controlled display 400 is coupled to the vault processor (not shown) for controlling certain aspects of operation. Processor code provides for a list of users 410 including a username, an actual name, and contact information such as an email address. An administrator may be able to alter or control the user's information and permissions 412. For example, an administrator may select which door to control and what the keys the user must select to gain access. In addition, an administrator may be able to select conditions for moving the barrier, such as days of the week, or times of day as shown in area 414.

In addition to setting up user accounts, and time-locked access, software (including mobile applications) may communicate with the vault processor to allow for single use entry to a facility. This provides for remote operation such as letting a user in without an access code. It also allows for closing (or verifying that a door is closed) remotely in cases where a user forgot to close the door.

### Alerts

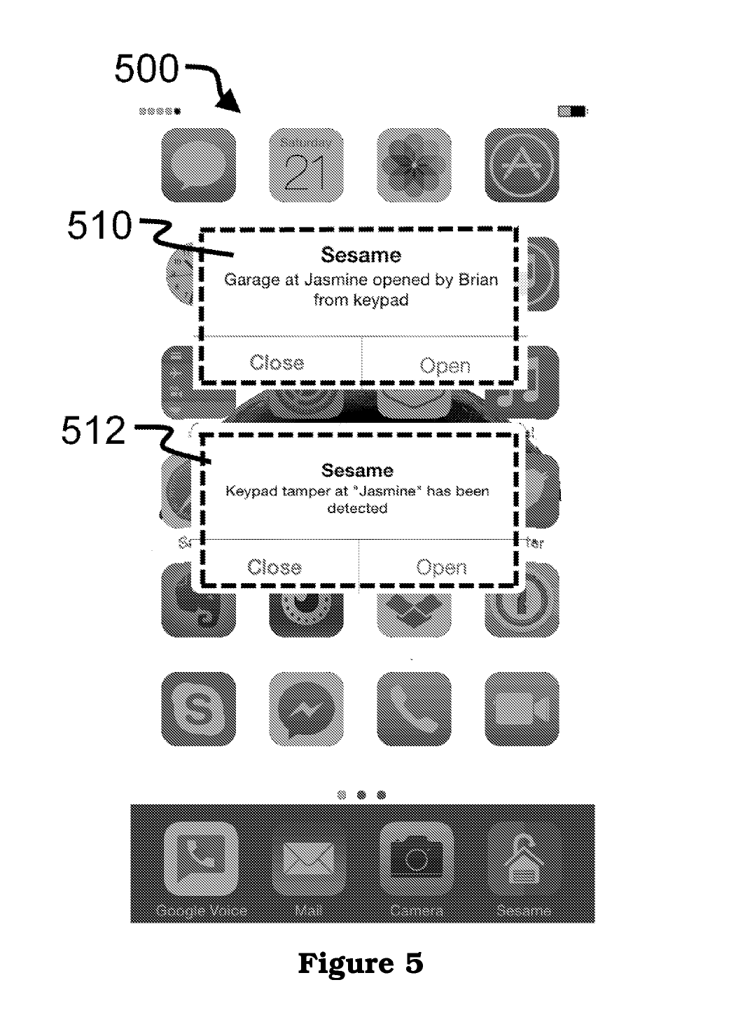

FIG. 5 shows a mobile application embodying differing alerts 500. The mobile application may be coupled to the vault processor through conventional Internet access means such as an access point (not shown). In FIG. 5 an alert 510 notifies the mobile device user that an authorized user “Brian” opened the garage door at a facility “Jasmine”. This allows for an administrator or other designated participant (for example and without limitation, a parent), to know when someone enters a facility. The vault processor is operable to provide alerts for all conditions likely to affect operation of a facility access system.

The mobile application may also show warnings such as failed entry attempts or tampering. Item 512 shows an alert indicating keypad tampering. Keyboard tampering may be effectuated by counting entry code errors, too many attempts, and the like. Tampering may also be detected with the loss of the RF signal. For example and without limitation, if the vault processor in the secure equipment loses connection with the exposed equipment, and alert may be sent to indicate a user stole the device or that the battery may be dead.

### Combinations

Enclosed herein are examples of differing aspects according to the current disclosure. These should not be read as limiting in any way. For example and without limitation, multiple barriers may be controlled using a single exposed area, or a single vault processor coupled to the Internet. Similarly multiple key or vault processors may be coupled together to provide more powerful capabilities for a large facility which may control multiple barriers.

Certain embodiments may be effectuated using the information in the attached appendix which is incorporated by reference as if fully set forth herein.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A device including:
a processor couple to a transceiver, said processor further coupled to a network;
a memory, said memory coupled to the processor;
an input device, said input device coupled to the transceiver and disposed remotely from the processor;
a barrier, said barrier coupled to a barrier controller, said barrier controller coupled to the processor, and
wherein the barrier controller operates the barrier in response to control information generated by the processor.

2. The device of claim 1 wherein the input device is a keypad.

3. The device of claim 1 wherein the input device is coupled to a second processor, said second processor operative to communicate electronically through the transceiver.

4. The device of claim 1 wherein the memory includes user information and password information.

5. The device of claim 1 wherein the network is the Internet.

6. A method including:
coupling a first processor to a network;
coupling the first processor to a transceiver;
coupling an input device to a second processor, said second processor coupled to a second transceiver disposed remotely from the first processor;
coupling the first processor to a barrier controller;
exposing the barrier controller operations to a remote user,
wherein the barrier controller operates the barrier in response to information from the remote user.

7. The method of claim 6 wherein said exposing is through the network.

8. The method of claim 6 wherein said exposing is through the transceiver.

9. The method of claim 6 wherein the input device is a keypad.

10. The method of claim 6 wherein the first processor communicates with the second processor through the transceiver.

11. One or more processor readable storage devices having processor readable, non-transitory, code embodied thereon, said processor readable code for programming method including:
exposing a remote user to the processor;
controlling a barrier controller in response to information from the remote user.
